(19) United States
(12) Patent Application Publication
(10) Pub. No.: US 2024/0300028 A1
(43) Pub. Date: Sep. 12, 2024

(54) CUTTING TOOL

(71) Applicant: AISIN AW INDUSTRIES CO., LTD, Fukui (JP)

(72) Inventors: Daichi YAMAGUCHI, Fukui (JP); Kazuyoshi MIYAMOTO, Fukui (JP); Makoto YAMAGUCHI, Fukui (JP)

(73) Assignee: AISIN FUKUI CORPORATION, Fukui (JP)

(21) Appl. No.: 18/547,580

(22) PCT Filed: Feb. 24, 2021
(86) PCT No.: PCT/JP2021/006893

§ 371 Date: Aug. 23, 2023

(51) Int. Cl. B23B 27/16

(52) U.S. Cl. CPC B23B 27/1611; B23B 2200/0447; B23B 2200/245

(57) ABSTRACT

A cutting tool according to this invention includes a cutting edge configured to cut a workpiece; a rake surface configured to come in contact with a chip, which appears when the workpiece is cut by the cutting edge; and a relieved surface configured to come in contact with a to-be-cut surface of the workpiece. A plurality of first grooves are formed in the cutting edge side of the rake surface. A plurality of second grooves are formed in the cutting edge side of the relieved surface.

### TECHNICAL FIELD

The present invention relates to a cutting tool, and particularly to a cutting tool with a plurality of grooves formed.

### BACKGROUND ART

Conventionally, a cutting tool with a plurality of grooves formed is known. Such a cutting tool is disclosed in Japanese Patent Laid-Open Publication No. JP 2009-202283, for example.

Japanese Patent Laid-Open Publication No. JP 2009-202283 discloses a cutting tool including a cutting edge formed along a ridge where a rake surface and a relieved surface intersect each other. In the cutting tool disclosed in Japanese Patent Laid-Open Publication No. JP 2009-202283, a wavy shape (a plurality of grooves) is formed on the cutting edge side of the rake surface in a regular arrangement. In the cutting tool disclosed in Japanese Patent Laid-Open Publication No. JP 2009-202283, because the wavy shape is formed on the rake surface to serve as an oil reservoir for cutting fluid, a frictional resistance between the rake surface and a chip can be reduces when a workpiece is cut, and as a result wearing of the rake surface can be reduced.

### PRIOR ART

### Patent Document

Patent Document 1: Japanese Patent Laid-Open Publication No. JP 2009-202283

### SUMMARY OF THE INVENTION

### Problems to be Solved by the Invention

Although a plurality of grooves are formed on the rake surface so that wearing of the rake surface can be reduced in the cutting tool disclosed in Japanese Patent Laid-Open Publication No. JP 2009-202283, wearing of surfaces other than the rake surface (e.g., relieved surface) is not taken in consideration. For this reason, in the cutting tool disclosed in Japanese Patent Laid-Open Publication No. JP 2009-202283, even if the rake surface does not wear out, the tool may be necessarily replaced. Consequently, in the cutting tool disclosed in Japanese Patent Laid-Open Publication No. JP 2009-202283, there is a problem that its tool life may be reduced by

The present invention is intended to solve the above problems, and one object of the present invention is to provide a cutting tool capable of preventing reduction of its tool life by reducing wearing of both its rake surface and relieved surface.

### Means for Solving the Problems

In order to attain the aforementioned object, a cutting tool according to an aspect of the present invention includes a cutting edge configured to cut a workpiece; a rake surface including a part configured to come in contact with a chip, which appears when the workpiece is cut by the cutting edge; and a relieved surface including a part configured to come in contact with a to-be-cut surface of the workpiece, wherein a plurality of first grooves are formed in the cutting edge side of the rake surface; and a plurality of second grooves are formed in the cutting edge side of the relieved surface.

In the cutting tool according to this aspect of the present invention, as discussed above, a plurality of first grooves are formed in the cutting edge side of the rake surface, and a plurality of second grooves are formed in the cutting edge side of the relieved surface. Accordingly, when a workpiece is cut, a frictional resistance between the rake surface and a chip can be reduced by the plurality of first grooves so that wearing of the rake surface can be reduced, and a frictional resistance between the relieved surface and the to-be-cut surface can be reduced by the plurality of second grooves so that wearing of the relieved surface can be reduced. Therefore, wearing of both its rake surface and relieved surface can be reduced whereby preventing reduction of the tool life.

In the cutting tool according to the aforementioned aspect, it is preferable that the plurality of first grooves extend on the rake surface in a direction intersecting a/the direction in which a chip is ejected. According to this configuration, because an ejected chip is unlikely to stay in the plurality of first grooves as compared with a case in which the plurality of first grooves extend on the rake surface in the direction in which a chip is ejected, it is possible to prevent reduction of an amount of cutting fluid that can be stored in the plurality of first grooves. As a result, the cutting fluid is more likely to stay in an area where the plurality of first grooves are formed on the rake surface, and consequently wearing of the rake surface can be effectively reduced.

In this configuration, it is preferable that the plurality of first grooves extend on the rake surface in a direction substantially orthogonal to the direction in which a chip is ejected. According to this configuration, because an ejected chip can be reliably prevented from staying in the plurality of first grooves, it is possible to reliably prevent reduction of an amount of cutting fluid that can be stored in the plurality of first grooves.

In the cutting tool according to the aforementioned aspect, it is preferable that the plurality of second grooves extend on the relieved surface in a cutting direction in which the workpiece is cut by the cutting edge. Because a direction in which the plurality of second grooves extend is unlikely to disagree with a direction in which the cutting fluid is supplied (generally, cutting fluid is often supplied from a backward side of the cutting direction, a diagonally backward place, etc.), this configuration helps the cutting fluid supplied to an area of the relieved surface where the plurality of second grooves are formed to reach a part in proximity to the cutting edge through the plurality of second grooves.

In the cutting tool according to the aforementioned aspect, it is preferable that the plurality of first grooves have a groove width and a groove depth greater than at least hard particles, which appear between the rake surface and the chip when the workpiece is cut. According to this configuration, hard particles that appear between the rake surface and a chip do not stay outside the first grooves and are likely to enter the grooves. As a result, the hard particles are unlikely to dig (ablate) the rake surface, and consequently, wearing of the rake surface can be effectively reduced as compared with a case in which the hard particles, which appear between the rake surface and a chip, do not enter the first grooves but stay outside the first grooves. The “hard particles, which appear between the rake surface and a chip” refer to pieces of the workpiece that fall from the chip of the workpiece, pieces of the cutting tool that are scratched off the rake surface, etc.

In the cutting tool according to the aforementioned aspect, it is preferable that the rake surface has a chip handler configured to bend a chip toward a side opposite to the rake surface, and that a first groove formation area in which plurality of first grooves are formed does not overlap the chip handler on the rake surface. According to this configuration, it is possible to prevent the first groove formation area from becoming a complicated structure as compared with a case in which the first groove formation area overlaps the chip handler.

In this configuration, it is preferable that the chip handler is arranged in a central part of the rake surface in a direction orthogonal to a direction in which a chip is ejected, and that the first groove formation area is formed in a U shape so as to surround the chip handler. According to this configuration, the groove formation area can be easily provided so as not to overlap the chip handler on the rake surface.

In the cutting tool according to the aforementioned aspect, it is preferable that a first groove formation area in which the plurality of first grooves are formed extends from the cutting edge side toward a side opposite to the cutting edge on the rake surface. According to this configuration, because the first groove formation area extends toward a side opposite to the cutting edge on the rake surface, a part that is out of contact with a chip (a part to which the cutting fluid can be supplied) can be easily provided in the first groove formation area. As a result, the cutting fluid can be more easily supplied to the plurality of first grooves as compared with a case in which the first groove formation area does not extend toward the side opposite to the cutting edge.

In the cutting tool according to the aforementioned aspect, it is preferable that the plurality of second grooves have a groove width and a groove depth greater than at least hard particles, which appear between the relieved surface and the to-be-cut surface when the workpiece is cut. According to this configuration, hard particles that appear between the relieved surface and the to-be-cut surface do not stay outside the second grooves and are likely to enter the second grooves. As a result, the hard particles are unlikely to dig (ablate) the relieved surface, and consequently, wearing of the relieved surface can be effectively reduced as compared with a case in which the hard particles, which appear between the relieved surface and the to-be-cut surface, do not enter the second grooves but stay outside the second grooves. The “hard particles, which appear between the relieved surface and the to-be-cut surface” refer to pieces of the workpiece that are scratched off the to-be-cut surface, pieces of the cutting tool that are scratched off the relieved surface, etc., when the workpiece is cut.

In the cutting tool according to the aforementioned aspect, it is preferable that the plurality of second grooves has a groove depth smaller than its groove width. According to this configuration, because the depth of the second grooves is relatively small, a shape of the second groove formed on the relieved surface can be prevented from stamping onto the to-be-cut surface of the workpiece that will come in contact with the relieved surface.

In the cutting tool according to the aforementioned aspect, it is preferable that the plurality of second grooves extend on the relieved surface from the cutting edge side to a part in proximity to an edge on a side opposite to the cutting edge. According to this configuration, an area of the relieved surface where the plurality of second grooves are formed can be relatively large, cutting fluid can be easily suppled to the second grooves.

### Effect of the Invention

According to the present invention, wearing of both its rake surface and relieved surface can be reduced whereby preventing reduction of the tool life.

### BRIEF DESCRIPTION OF THE DRAWINGS

FIG. 1 Diagram of a cutting tool according to one embodiment of the present invention.

FIG. 2 Enlarged perspective diagram of a part P in FIG. 1.

FIG. 3 Diagram illustrating contact between a cutting tool and a workpiece when the workpiece is cut.

FIG. 4 Diagram corresponding to FIG. 2 as viewed in a direction A.

FIG. 5 Cross-sectional diagram taken along a line 1100-1100 in FIG. 4.

FIG. 6 Diagram corresponding to FIG. 2 as viewed in a direction B.

FIG. 7 Cross-sectional diagram taken along a line 1200-1200 in FIG. 6.

FIG. 8 Diagram showing a first groove formation area according to a first modified embodiment of the embodiment of the present invention.

FIG. 9 Diagram showing a first groove formation area according to a second modified embodiment of the embodiment of the present invention.

FIG. 10 Diagram showing a first groove formation area according to a third modified embodiment of the embodiment of the present invention.

FIG. 11 Diagram showing a first groove formation area according to a fourth modified embodiment of the embodiment of the present invention.

FIG. 12 Diagram showing a second groove formation area according to a fifth modified embodiment of the embodiment of the present invention.

FIG. 13 Diagram showing a second groove formation area according to a sixth modified embodiment of the embodiment of the present invention.

FIG. 14 Diagram showing a second groove formation area according to a seventh modified embodiment of the embodiment of the present invention.

FIG. 15 Diagram showing a first groove formation area according to an eighth modified embodiment of the embodiment of the present invention.

### MODES FOR CARRYING OUT THE INVENTION

Embodiments embodying the present invention are hereinafter described on the basis of the drawings.

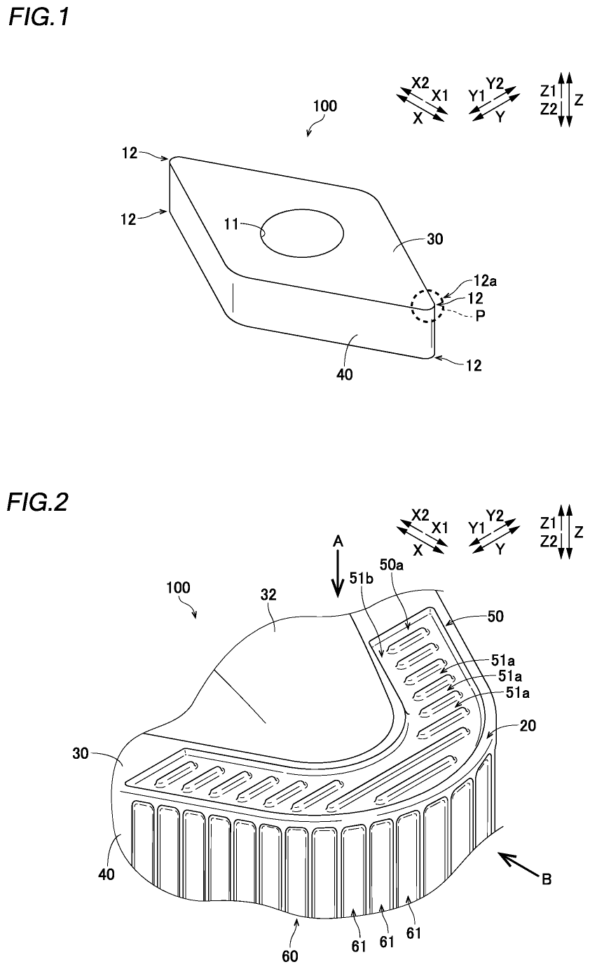

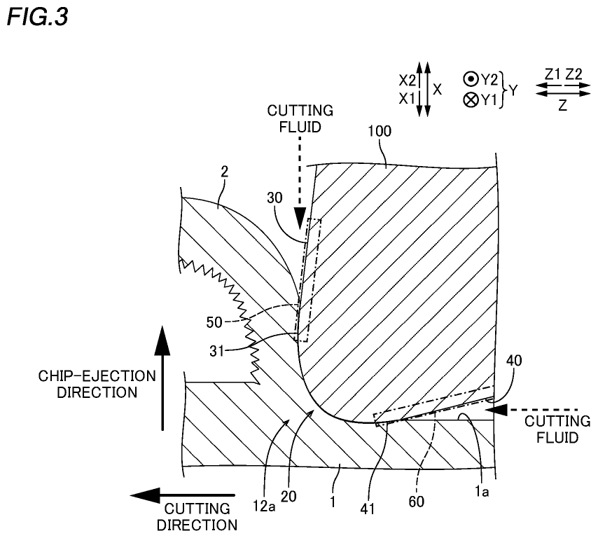

A cutting tool 100 according to one embodiment of the present invention is now described with reference to FIGS. 1 to 7. The cutting tool 100 serves to cut a workpiece 1, such as metal (see FIG. 3).

As shown in FIG. 1, the cutting tool 100 is a cutting edge piece (tip) of a tip-replaceable tool. An attachment hole 11 for attaching the cutting tool 100 to a tool body (not shown) as the tip is formed in a central part of the cutting tool 100.

The cutting tool 100 has a parallelepiped shape having two bottom surfaces, which has a rhombic shape and arranged parallel to each other, and four side surfaces, which are interposed between the two bottom surfaces. In the following description, a direction in which a longer diagonal line of the bottom surface extends, a direction in which a shorter diagonal line of the bottom surface extends, and a direction in which the sides extend are defined as X, Y and Z directions, respectively. One side in the X, Y and Z directions are defined as X1, Y1, and Z1 sides, respectively, while another side in the X, Y and Z directions are defined as X2, Y2, and Z2 sides, respectively.

In the cutting tool 100, a plurality of vertices (corners 12) of the parallelepiped shape can be used as a cutting edge 20 (described later) for cutting the workpiece 1 (see FIG. 3). In this specification, an example in which one of the vertices (corners 12a) that is located on the one side (X1 side) in the X direction and the one side (Z1 side) in the Z direction of the cutting tool 100 having the parallelepiped shape is used to cut the workpiece 1 will be described. In this case, a cutting direction of the workpiece 1 (see FIG. 3) is defined by the Z1 direction.

As shown in FIG. 2, the cutting tool 100 has a cutting edge 20, a rake surface 30, and a relieved surface 40.

The cutting edge 20 is formed along a ridge where the rake surface 30 and the relieved surface 40 intersect each other. As shown in FIG. 3, the cutting edge 20 has a round surface shape. The cutting edge 20 is configured to dig into the workpiece 1 when cutting the workpiece 1.

The rake surface 30 includes a part configured to come in contact with a chip 2 that appears when the workpiece 1 is cut by the cutting edge 20. The rake surface 30 extends in a direction (X2 direction) in which the chip 2 is ejected when cutting the workpiece 1. When the workpiece 1 is cut by the cutting tool 100, cutting fluid is supplied to the rake surface 30 from a side (X2 side) opposite to the cutting edge 20.

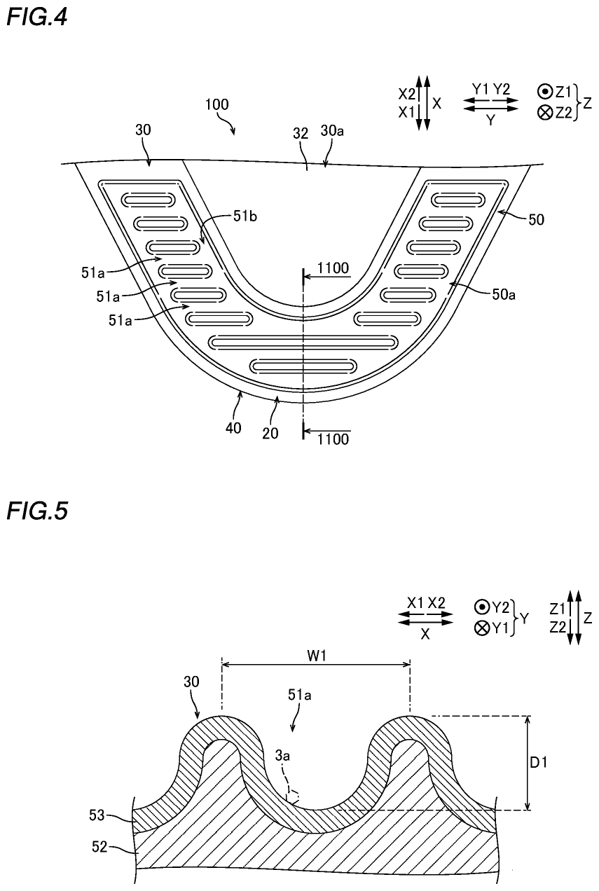

As shown in FIG. 2, a chip handler 32 is formed on the rake surface 30. The chip handler 32 bulges from the rake surface 30. The chip handler 32 is arranged in a central part 30a (see FIG. 4) of the rake surface 30 in a direction (Y direction) orthogonal to a direction in which a chip 2 is ejected (X2 direction). As shown in FIG. 3, the chip handler 32 is configured to bend the chip 2, which is ejected in the X2 direction, toward a side (Z1 side) opposite to the rake surface 30. Note that the chip handler 32 is not shown in FIG. 3.

The relieved surface 40 is a surface that includes a part 41 configured to come in contact with a to-be-cut surface 1a of the workpiece 1 when the workpiece 1 is cut. The relieved surface 40 is formed to extend along the to-be-cut surface 1a when the workpiece 1 is cut. In other words, the relieved surface 40 and the to-be-cut surface 1a extend in the Z direction. When the workpiece 1 is cut by the cutting tool 100, cutting fluid is supplied to the relieved surface 40 from the side (Z2 side) opposite to the cutting edge 20.

Here, in this embodiment, as shown in FIG. 2, a plurality of first grooves 51a are formed on a cutting edge 20 side of the rake surface 30. A first groove formation area 50 in which the plurality of first grooves 51a are formed extends from the cutting edge 20 side (X1 side) toward the side (X2 side) opposite to the cutting edge 20 on the rake surface 30. As shown in FIG. 3, the first groove formation area 50 is formed to extend toward the side (X2 side) opposite to the cutting edge 20 so as to form a part that does not come in contact the chip 2 of the workpiece 1 at all when the cutting tool 100 cuts the workpiece 1.

Specifically, as shown in FIG. 4, the first groove formation area 50 are formed along the cutting edge 20 on the rake surface 30. The groove formation area 50 is formed in a U shape so as to surround the chip handler 32. In other words, the first groove formation area 50 does not overlap the chip handler 32 on the rake surface 30.

As shown in FIG. 5, the plurality of first grooves 51a have a groove width W1 and a groove depth D1 greater than at least hard particles 3a, which appear between the rake surface 30 and the chip 2 when the workpiece 1 is cut. The plurality of first grooves 51a are formed in rounded peaks and troughs. The “hard particles 3a, which appear between the rake surface 30 and the chip 2” refer to pieces of the workpiece 1 that fall from the chip 2, pieces of the cutting tool 100 that are scratched off the rake surface 30, etc., when the workpiece 1 is cut.

A coating 53 is applied on a surface of a base material 52 in the first groove formation area 50 in which the plurality of first grooves 51a are formed. For example, the base material 52 is a cermet or cemented carbide. For example, a titanium compound (titanium carbide, titanium carbo-nitride, etc.), alumina or the like are used for the coating 53.

Also, as shown in FIG. 4, the plurality of first grooves 51a are arranged adjacent to each other. The plurality of first grooves 51a extend on the rake surface 30 in a direction (Y direction) substantially orthogonal to the direction (X2 direction) in which the chip 2 is ejected. In other words, the plurality of first grooves 51a extend on the rake surface 30 in a direction intersecting the direction in which the chip 2 is ejected (in a direction different from the direction in which the chip 2 is ejected).

In the cutting tool 100, a connection groove 51b, which connects the plurality of first grooves 51a to each other, is formed in the first groove formation area 50. Specifically, the connection groove 51b, which connects the plurality of first grooves 51a to each other, is arranged on an outer edge 50a of the first groove formation area 50, and the first groove formation area 50 is formed in a U shape. More specifically, the connection groove 51b, which connects the plurality of first grooves 51a to each other, is a closure extending along the outer edge 50a so as to surround the first groove formation area 50.

In this embodiment, as shown in FIG. 2, a plurality of second grooves 61 are formed on a cutting edge 20 side of the relieved surface 40. The second groove formation area 60 in which the plurality of second grooves 61 are formed extends from the cutting edge 20 side (Z1 side) toward the side (Z2 side) opposite to the cutting edge 20 on the relieved surface 40.

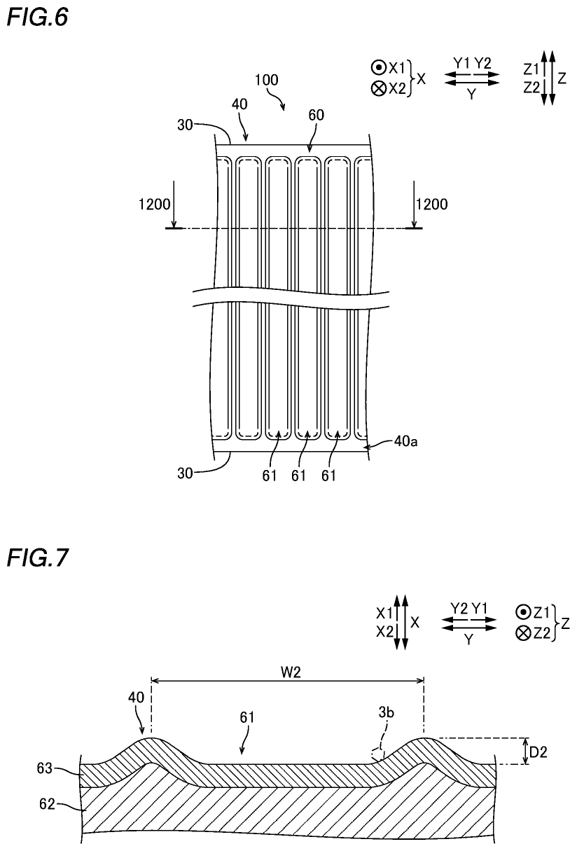

Specifically, as shown in FIG. 6, the plurality of second grooves 61 extend on the relieved surface 40 in the cutting direction (Z direction) along which the workpiece 1 is cut by the cutting edge 20. Also, the plurality of second grooves 61 extend on the relieved surface 40 from the cutting edge 20 side (Z1 side) to a part in proximity to an edge 40a on a side (Z2 side) opposite to the cutting edge 20. That is, in the cutting tool 100, the plurality of second grooves 61 extend on the relieved surface 40 from a part in proximity to the vertex 12 on one side (Z1 side) in the Z direction to the part in proximity to the vertex 12 on another side (Z2 side). Accordingly, as shown in FIG. 3, a part that does not come in contact the to-be-cut surface 1a of the workpiece 1 at all when the cutting tool 100 cuts the workpiece 1 is formed in the second groove formation area 60.

As shown in FIG. 7, the plurality of second grooves 61 have a groove width W2 and a groove depth D2 greater than at least hard particles 3b, which appear between the relieved surface 40 and the to-be-cut surface 1a when the workpiece 1 is cut. The groove depth D2 of the plurality of second grooves 61 is smaller than the groove width W2. The plurality of second grooves 61 are formed by rounded peaks. The “hard particles 3b, which appear between the relieved surface 40 and the to-be-cut surface 1a” refer to pieces of the workpiece 1 that are scratched off the to-be-cut surface 1a, pieces of the cutting tool 100 that are scratched off the relieved surface 40, etc., when the workpiece 1 is cut.

A coating 63 is applied on a surface of a base material 62 in the second groove formation area 60 in which the plurality of second grooves 61 are formed. For example, the base material 62 is a cermet or cemented carbide. For example, a titanium compound (titanium carbide, titanium carbo-nitride, etc.), alumina or the like are used for the coating 63.

The first groove formation area 50 (the plurality of first grooves 51a and the connection groove 51b) and the second groove formation area 60 (the plurality of second grooves 61) are formed by die molding, laser machining, etc.

### Advantages of the Embodiment

In this embodiment, the following advantages are obtained.

In this embodiment, a plurality of first grooves 51a are formed on a cutting edge 20 side of the rake surface 30. Also, a plurality of second grooves 61 are formed on a cutting edge 20 side of the relieved surface 40. Accordingly, when a workpiece 1 is cut, a frictional resistance between the rake surface 30 and a chip 2 can be reduced by the plurality of first grooves 51a so that wearing of the rake surface 30 can be reduced, and a frictional resistance between the relieved surface 40 and the to-be-cut surface 1a can be reduced by the plurality of second grooves 61 so that wearing of the relieved surface 40 can be reduced. Therefore, wearing of both the rake surface 30 and the relieved surface 40 can be reduced whereby preventing reduction of the tool life.

In this embodiment, as discussed above, the plurality of first grooves 51a extend on the rake surface 30 in a direction intersecting the direction (X2 direction) in which the chip 2 is ejected. Accordingly, because the ejected chip 2 is unlikely to stay in the plurality of first grooves 51a as compared with a case in which the plurality of first grooves 51a extend on the rake surface 30 in the direction in which the chip 2 is ejected, it is possible to prevent reduction of an amount of cutting fluid that can be stored in the plurality of first grooves 51a. As a result, the cutting fluid is more likely to stay in an area (first groove formation area 50) where the plurality of first grooves 51a are formed on the rake surface 30, and consequently wearing of the rake surface 30 can be effectively reduced.

In this embodiment, as discussed above, the plurality of first grooves 51a extend on the rake surface 30 in a direction (Y direction) substantially orthogonal to the direction (X2 direction) in which the chip 2 is ejected. Accordingly, because the ejected chip 2 can be reliably prevented from staying in the plurality of first grooves 51a, it is possible to reliably prevent reduction of an amount of cutting fluid that can be stored in the plurality of first grooves 51a.

In this embodiment, as discussed above, the plurality of second grooves 61 extend on the relieved surface 40 in a cutting direction (X2 direction) in which the workpiece 1 is cut by the cutting edge 20. Accordingly, because a direction in which the plurality of second grooves 61 extend is unlikely to disagree with a direction in which the cutting fluid is supplied, it is possible to help the cutting fluid supplied to an area (second groove formation area 60) of the relieved surface 40 where the plurality of second grooves 61 are formed to reach a part in proximity to the cutting edge 20 through the plurality of second grooves 61.

In this embodiment, as discussed above, the plurality of first grooves 51a have a groove width W1 and a groove depth D1 greater than at least hard particles 3a, which appear between the rake surface 30 and the chip 2 when the workpiece 1 is cut. Accordingly, hard particles 3a, which appear between the rake surface 30 and the chip 2, do not stay outside the first grooves 51a and are likely to enter the first grooves 51a. As a result, the hard particles 3a are unlikely to dig (ablate) the rake surface 30, and consequently wearing of the rake surface 30 can be effectively reduced as compared with a case in which the hard particles 3a, which appear between the rake surface 30 and the chip 2, do not enter the first grooves 51a but stay outside the first grooves 51a.

Also, in this embodiment, as discussed above, a chip handler 32 is provided on the rake surface 30 to bend a chip 2 toward a side opposite to the rake surface 30. In addition, the first groove formation area 50 in which plurality of first grooves 51a are formed does not overlap the chip handler 32 on the rake surface 30. Accordingly, it is possible to prevent the first groove formation area 50 from becoming a complicated structure as compared with a case in which the first groove formation area 50 overlaps the chip handler 32.

In this embodiment, as discussed above, the chip handler 32 is arranged in a central part 30a of the rake surface 30 in a direction (Y direction) orthogonal to a direction in which the chip 2 is ejected (X2 direction). In addition, the first groove formation area 50 is formed in a U shape so as to surround the chip handler 32. Accordingly, the first groove formation area 50 can be easily provided so as not to overlap the chip handler 32 on the rake surface 30.

In this embodiment, as discussed above, a first groove formation area 50 in which the plurality of first grooves 51a are formed extends from the cutting edge 20 side toward the side opposite to the cutting edge 20 on the rake surface 30. Accordingly, because the first groove formation area 50 extends toward a side opposite to the cutting edge 20 on the rake surface 30, a part that is out of contact with a chip 2 (a part to which the cutting fluid can be supplied) can be easily provided in the first groove formation area 50. As a result, the cutting fluid can be more easily supplied to the plurality of first grooves 51a as compared with a case in which the first groove formation area 50 does not extend toward the side opposite to the cutting edge 20.

In this embodiment, as discussed above, the plurality of second grooves 61 have a groove width W2 and a groove depth D2 greater than at least hard particles 3b, which appear between the relieved surface 40 and the to-be-cut surface 1a when the workpiece 1 is cut. Accordingly, hard particles 3b, which appear between the relieved surface 40 and the to-be-cut surface 1a, do not stay outside the second grooves 61 and are likely to enter the second grooves 61. As a result, the hard particles 3b are unlikely to dig (ablate) the relieved surface 40, and consequently, wearing of the relieved surface 40 can be effectively reduced as compared with a case in which the hard particles 3b, which appear between the relieved surface 40 and the to-be-cut surface 1a, do not enter the second grooves 61 but stay outside the second grooves 61.

In this embodiment, as discussed above, the groove depth D2 of the plurality of second grooves 61 is smaller than the groove width W2. Accordingly, because the depth of the second grooves 61 is relatively small, a shape of the second groove 61 formed on the relieved surface 40 can be prevented from stamping onto the to-be-cut surface 1a the workpiece 1 that will come in contact with the relieved surface 40.

In this embodiment, as discussed above, the plurality of second grooves 61 extend on the relieved surface 40 from the cutting edge 20 side to a part in proximity to an edge 40a on a side opposite to the cutting edge 20. Accordingly, an area of the relieved surface 40 where the plurality of second grooves 61 are formed can be relatively large, cutting fluid can be easily suppled to the second grooves 61.

### Modified Embodiment

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

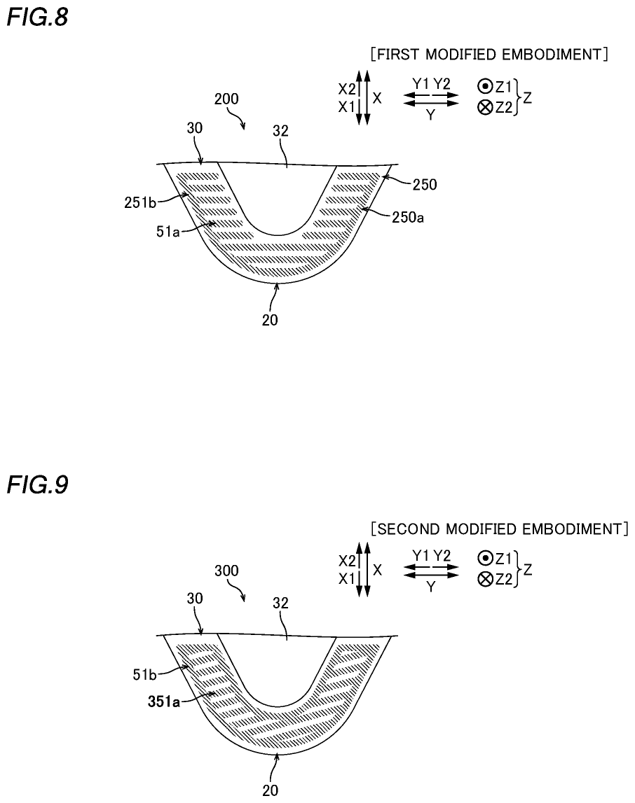

While the example in which the connection groove 51b, which connects the plurality of first grooves 51a to each other, is a closure extending along the outer edge 50a so as to surround the first groove formation area 50 has been shown in the aforementioned embodiment, the present invention is not limited to this. In the present invention, as shown in a cutting tool 200 according to a first modified embodiment of FIG. 8, a connection groove 251b, which connects the plurality of first grooves 51a to each other, can be a non-closed line extending along an outer edge 250a so as to surround a first groove formation area 250. While the example in which the connection groove 251b is formed along the entire of the cutting edge 20 of the outer edge 250a of the first groove formation area 250 has been shown in FIG. 8, the connection groove may be formed along a part of the cutting edge 20 of the outer edge 250a of the first groove formation area 250 or be formed on a side opposite to the cutting edge 20 of the outer edge 250a of the first groove formation area 250.

While the example in which the plurality of first grooves 51a extend on the rake surface 30 in a direction (Y direction) substantially orthogonal to the direction (X2 direction) in which the chip 2 is ejected has been shown in the aforementioned embodiment, the present invention is not limited to this. In the present invention, as shown in a cutting tool 300 according to a second modified embodiment of FIG. 9, a plurality of first grooves 351a may extend on the rake surface 30 in an inclined direction with respect to in the direction (Y direction) substantially orthogonal to the direction (X2 direction) in which the chip 2 is ejected.

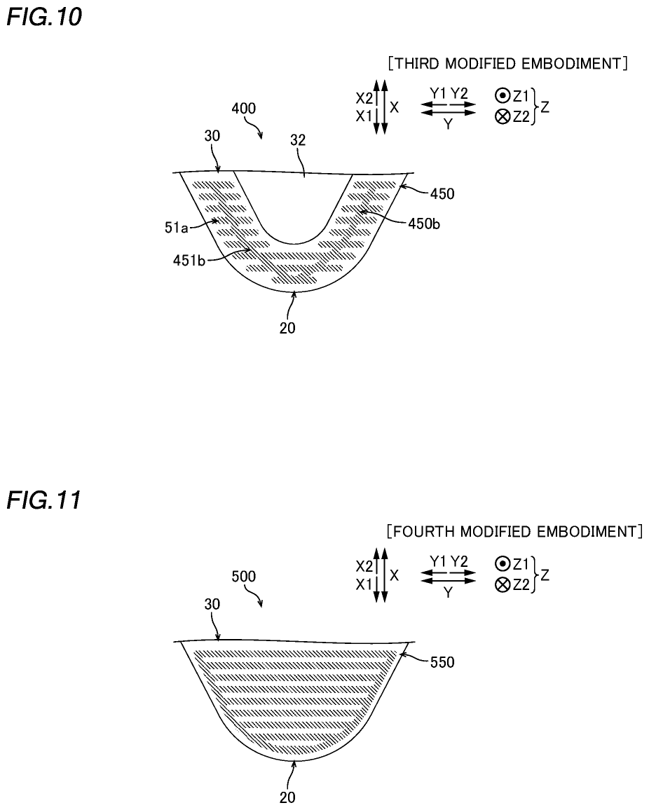

While the example in which the connection groove 51b, which connects the plurality of first grooves 51a to each other, is arranged on an outer edge 50a of the first groove formation area 50 has been shown in the aforementioned embodiment, the present invention is not limited to this. In the present invention, as shown in a cutting tool 400 according to a third modified embodiment of FIG. 10, a connection groove 451b, which connects the plurality of first grooves 51a to each other, can be formed in a central part 450b of a first groove formation area 450.

While the example in which the groove formation area 50 is formed in a U shape so as to surround the chip handler 32 has been shown in the aforementioned embodiment, the present invention is not limited to this. In the present invention, as shown in a cutting tool 500 according to a fourth modified embodiment of FIG. 11, a first groove formation area 550 may be formed so as not to surround the chip handler 32 or be formed in a shape other than the U shape.

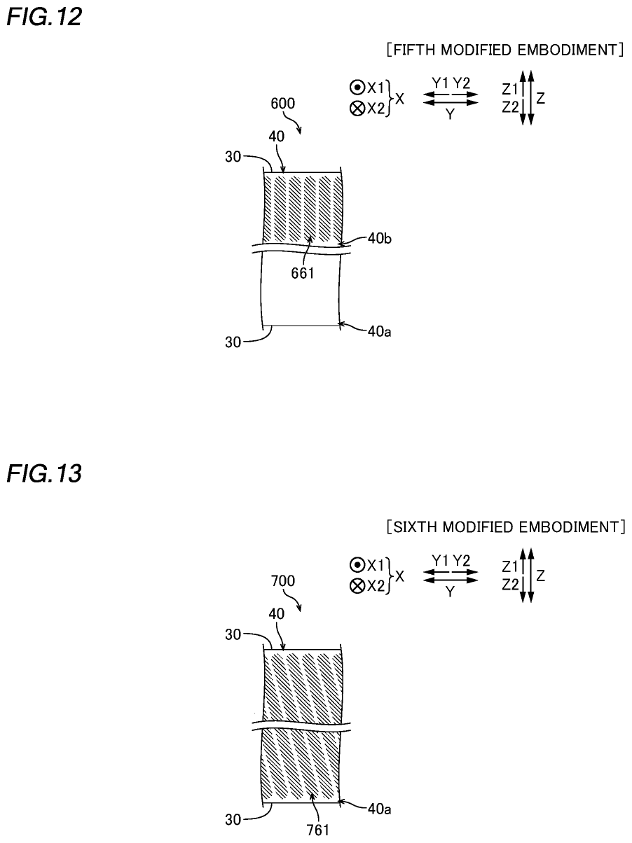

While the example in which the plurality of second grooves 61 extend on the relieved surface 40 from the cutting edge 20 side (Z1 side) to a part in proximity to an edge 40a on a side (Z2 side) opposite to the cutting edge 20 has been shown in the aforementioned embodiment, the present invention is not limited to this. In the present invention, as shown in a cutting tool 600 according to a fifth modified embodiment of FIG. 12, a plurality of second grooves 661 may extend on the relieved surface 40 from the cutting edge 20 side (Z1 side) to a central part 40b.

While the example in which the plurality of second grooves 61 extend on the relieved surface 40 in a cutting direction (Z direction) along which the workpiece 1 is cut by the cutting edge 20 has been shown in the aforementioned embodiment, the present invention is not limited to this. In the present invention, as shown in a cutting tool 700 according to a sixth modified embodiment of FIG. 13, a plurality of second grooves 761 may extend on the relieved surface 40 in an inclined direction with respect to the cutting direction (Z direction) along which the workpiece 1 is cut by the cutting edge 20.

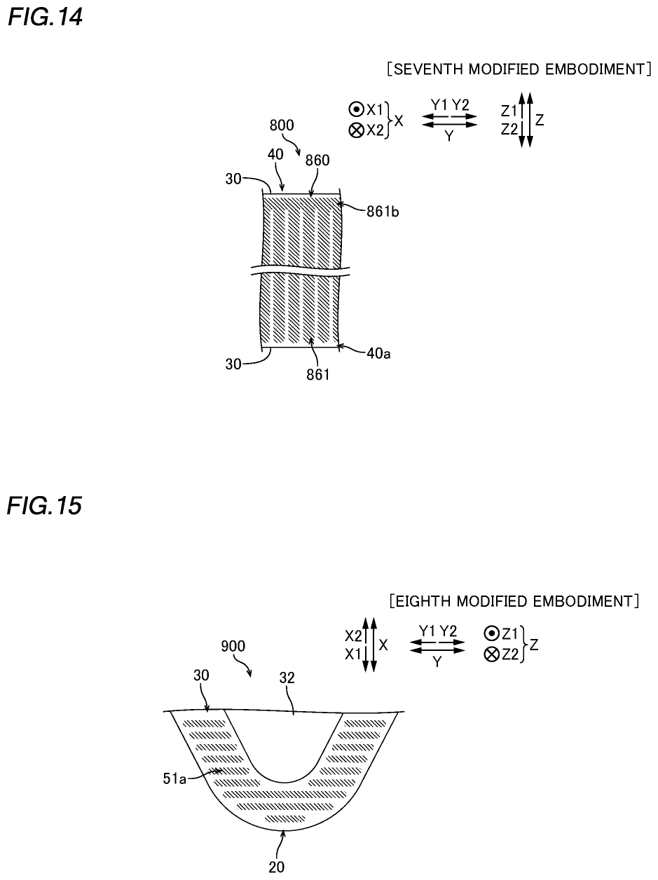

While the example in which the connection groove 51b, which connects the plurality of first grooves 51a to each other, is formed in the first groove formation area 50 has been shown in the aforementioned embodiment, the present invention is not limited to this. In the present invention, as shown in a cutting tool 800 according to a seventh modified embodiment of FIG. 14, a connection groove 861b, which connects a plurality of second grooves 861 to each other, may be formed in the second groove formation area 860. Also in a cutting tool 900 according to an eighth modified embodiment of FIG. 15, the connection groove 51b, which connects the plurality of first grooves 51a to each other may not be formed.

While the example in which the cutting tool 100 has a parallelepiped shape has been shown in the aforementioned embodiment, the present invention is not limited to this. In the present invention, the cutting tool may have a shape other than such a parallelepiped shape as long as it has a vertex (corner) that can be used as a cutting edge.

While the example in which the cutting tool 100 is a cutting edge piece (tip) of a tip-replaceable tool to be attached to a tool body has been shown in the aforementioned embodiment, the present invention is not limited to this. The invention may be applied to a cutting tool including a cutting edge (tip) integrally formed with a tool body.

### DESCRIPTION OF REFERENCE NUMERALS

1: workpiece
1a: to-be-cut surface (of workpiece)
2: chip
3a: hard particle (appears between rake surface and chip in cutting of workpiece)
3b: hard particle (appears between relieved surface and to-be-cut surface in cutting of workpiece)
20: cutting edge
30: rake surface
30a: central part in direction orthogonal to chip-ejection direction (on rake surface)
31: part in contact with chip (on rake surface)
32: chip handler
40: relieved surface
40a: edge on side opposite to cutting edge (of relieved surface)
41: part in contact with to-be-cut surface of workpiece (on relieved surface)
50, 250, 450, 550: first groove formation area
51a, 351a: first grooves
60: second groove formation area
61, 661, 761, 861: second grooves
100, 200, 300, 400, 500, 600, 700, 800, 900: cutting tool
D1: groove depth (of first groove)
D2: groove depth (of second groove)
W1: groove width (of first groove)
W2: groove width (of second groove)

1. A cutting tool comprising:
a cutting edge configured to cut a workpiece;
a rake surface including a part configured to come in contact with a chip, which appears when the workpiece is cut by the cutting edge; and
a relieved surface including a part configured to come in contact with a to-be-cut surface of the workpiece, wherein
a plurality of first grooves are formed in the cutting edge side of the rake surface; and
a plurality of second grooves are formed in the cutting edge side of the relieved surface.

2. The cutting tool according to claim 1, wherein the plurality of first grooves extend on the rake surface in a direction intersecting a direction in which the chip is ejected.

3. The cutting tool according to claim 2, wherein the plurality of first grooves extend on the rake surface in a direction substantially orthogonal to the direction in which the chip is ejected.

4. The cutting tool according to claim 1, wherein the plurality of second grooves extend on the relieved surface in a cutting direction in which the workpiece is cut by the cutting edge.

5. The cutting tool according to claim 1, wherein the plurality of first grooves have a groove width and a groove depth greater than at least hard particles, which appear between the rake surface and the chip when the workpiece is cut.

6. The cutting tool according to claim 1, wherein
the rake surface has a chip handler configured to bend the chip toward a side opposite to the rake surface; and
a first groove formation area in which plurality of first grooves are formed does not overlap the chip handler on the rake surface.

7. The cutting tool according to claim 6, wherein
the chip handler is arranged in a central part of the rake surface in a direction orthogonal to a/the direction in which the chip is ejected; and
the first groove formation area is formed in a U shape so as to surround the chip handler.

8. The cutting tool according to claim 1, wherein a/the first groove formation area in which the plurality of first grooves are formed extends from the cutting edge side toward a side opposite to the cutting edge on the rake surface.

9. The cutting tool according to claim 1, wherein the plurality of second grooves have a groove width and a groove depth greater than at least hard particles, which appear between the relieved surface and the to-be-cut surface when the workpiece is cut.

10. The cutting tool according to claim 1, wherein the plurality of second grooves has a groove depth smaller than its groove width.

11. The cutting tool according to claim 1, wherein the plurality of second grooves extend on the relieved surface from the cutting edge side to a part in proximity to an edge on a side opposite to the cutting edge.
